(19) United States
(12) Patent Application Publication
(10) Pub. No.: US 2020/0346869 A1
(43) Pub. Date: Nov. 5, 2020

(54) SUPERHYDROPHOBIC PLASTIC CONVEYOR COMPONENTS AND METHODS FOR THEIR MOLDING

(71) Applicant: Laitram, L.L.C., Harahan, LA (US)

(72) Inventors: Kejia Jin, Frisco, TX (US); Noshir Sheriar Pesika, New Orleans, LA (US); Shuchi P. Khurana, Metairie, LA (US); Jeremiah E. Oertling, Jefferson, LA (US)

(21) Appl. No.: 16/760,310

(22) PCT Filed: Oct. 23, 2018
(86) PCT No.: PCT/US2018/057095

§ 371 Date: Apr. 29, 2020

Related U.S. Application Data
(60) Provisional application No. 62/586,339, filed on Nov. 15, 2017.

(51) Int. Cl. B65G 15/42; B65G 17/08; B29C 45/26; B23K 26/386; B29D 29/06; B08B 17/06

(52) U.S. Cl. CPC B65G 15/42; B65G 17/08; B29C 45/263; B23K 2103/04; B29D 29/06; B08B 17/06; B65G 2207/26; B23K 26/386

(57) ABSTRACT

Superhydrophobic conveyor belt components and methods for molding those components out of thermoplastic polymers. The plastic components have superhydrophobic regions on outer surfaces that shed aqueous solutions and remain dry. The water-shedding regions are textured with a nano- or micro-structure that is rough enough to endow the region with superhydrophobic properties.

### BACKGROUND

The invention relates generally to power-driven conveyors and more particularly to plastic conveyor belt components with superhydrophobic surfaces and to methods for molding such components.

Hygienic conveyor systems are important in the food-processing industry. Because nooks and crannies in conveyor belts, conveyor frames, and other conveyor accessories harbor bacteria and other pathogens, frequent washing of the equipment is required. But pathogens can also reside on flat surfaces such as the conveying surface of a conveyor belt. Pathogens can remain and grow on the outer conveying surface of a conveyor belt after washing if the belt does not adequately shed the rinse water.

Superhydrophobic surfaces are difficult to wet and easily shed water. Water on a superhydrophobic surface beads up, and the bead rapidly slides down the surface when tilted. A hydrophilic surface, on the other hand, is easy to wet, but does not shed water well. That's because hydrophilic surfaces have higher surface energies than hydrophobic surfaces. As shown in FIG. 9, a water droplet 20 on a hydrophilic surface 22 spreads out on the surface and forms an acute contact angle α. (The contact angle α is the angle the tangent to the water droplet makes with the surface.) The contact angle α for a hydrophobic surface is obtuse (greater than 90°), and the contact angle for a superhydrophobic surface is greater than 150°, as shown in FIG. 10. The water droplet 20′ on the superhydrophobic surface 22′ beads up and does not spread out. The droplet 20′ is repelled by the surface. Texturing a surface adds pockets of air, which lowers the surface energy and makes it more hydrophobic.

### SUMMARY

A conveyor component made of plastic and embodying features of the invention comprises an outer surface having a superhydrophobic region with a superhydrophobic texture.

A conveyor belt made of plastic and embodying features of the invention comprises an outer surface having a superhydrophobic region with a superhydrophobic texture.

In another aspect, a method for making a conveyor component with a superhydrophobic surface region comprises: (a) forming a first cavity bounded by an inner face in a first steel mold half; (b) engraving a pattern of blind-ended microholes in the inner face of the first steel mold half with a laser; (c) forming a second cavity in a second steel mold half; (d) closing the mold halves so that the first and second cavities together define the shape of a conveyor component; (e) injecting a molten thermoplastic polymer into the first and second cavities to fill the cavities and the microholes; (f) applying heat and pressure to the first and second closed mold halves to form a conveyor component; (g) opening the first and second mold halves to release the conveyor component from the first and second cavities; and (h) wherein the thermoplastic polymer in the microholes produces micropillars that form a superhydrophobic surface region on the conveyor component.

### BRIEF DESCRIPTION OF THE DRAWINGS

FIG. 1 is an isometric view of a portion of a modular plastic conveyor belt constructed of belt modules embodying features of the invention.

FIG. 2 is an isometric view of a conveyor belt module as in the belt of FIG. 1 and an enlarged portion of the module's outer surface.

FIG. 3 is a depiction of the superhydrophobic surface of the module of FIG. 2.

FIG. 4 is a schematic diagram of a laser-engraving system used to engrave a mold for making a belt module as in FIG. 2.

FIG. 5 is an isometric view of a portion of one-half of a mold used to form a belt module as in FIG. 2.

FIG. 6 is a simplified side elevation view of a mold for making a belt module as in FIG. 2.

FIG. 7 is an enlarged isometric view of a portion of one-half of the mold of FIG. 6 showing a thermoplastic polymer filling microholes.

FIG. 8 shows a variety of conveyor components that can include superhydrophobic regions.

FIG. 9 depicts a water droplet on a hydrophilic surface.

FIG. 10 depicts a water droplet on a superhydrophobic surface.

### DETAILED DESCRIPTION

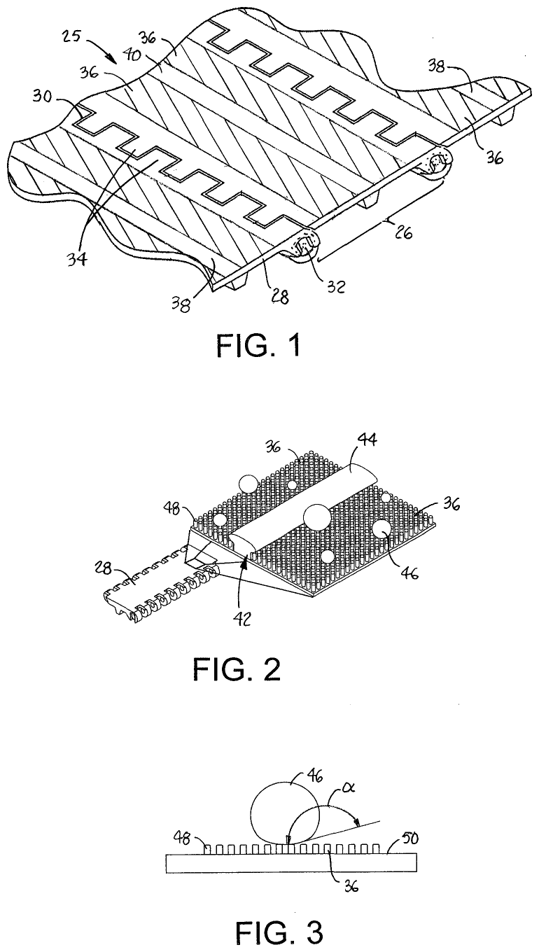

A modular plastic conveyor belt embodying features of the invention is shown in FIG. 1. The belt 25 is constructed of a series of rows 26 of one or more plastic belt modules 28 linked together end to end at hinge joints 30 by hinge rods 32 through interleaved hinge elements 34 between consecutive rows. Superhydrophobic regions 36 are formed on an outer conveying surface 38 of each module 28. The superhydrophobic regions 36 are formed by textured surface areas roughened by nano- or micro-scale asperities. The superhydrophobic regions 36 may cover the outer surface of the modules 28 entirely or partly. In this example, the superhydrophobic regions 36 on each module 28 are separated by a non-superhydrophobic strip 40 forming a drainage channel 42, as shown in FIG. 2. The strip 40 channels water 44 collected from the water droplets 46 received from the superhydrophobic regions 36.

The superhydrophobic texturing shown in FIG. 2 comprises a plurality of micropillars 48 arranged in a lattice pattern. The pattern may be a hexagonal lattice as in FIG. 2 or a square lattice as two examples. As shown in FIG. 3, a water droplet 46 sits atop the micropillars 48 and exhibits a contact angle α of greater than 150° because of the decreased contact area and the air trapped between adjacent micropillars. The micropillars 48 in the superhydrophobic region 36 extend from a base 50. The pillars 48 in this example are shown as generally parallel to each other. The height of the pillars 48 is between about 25 μm and about 500 μm. They are spaced apart a distance of between about 10 μm and about 100 μm. Their diameters, or widths, are between about 10 μm and about 200 μm. And the percentage of the area of the superhydrophobic region 36 occupied by the micropillars is between about 20% and about 70%.

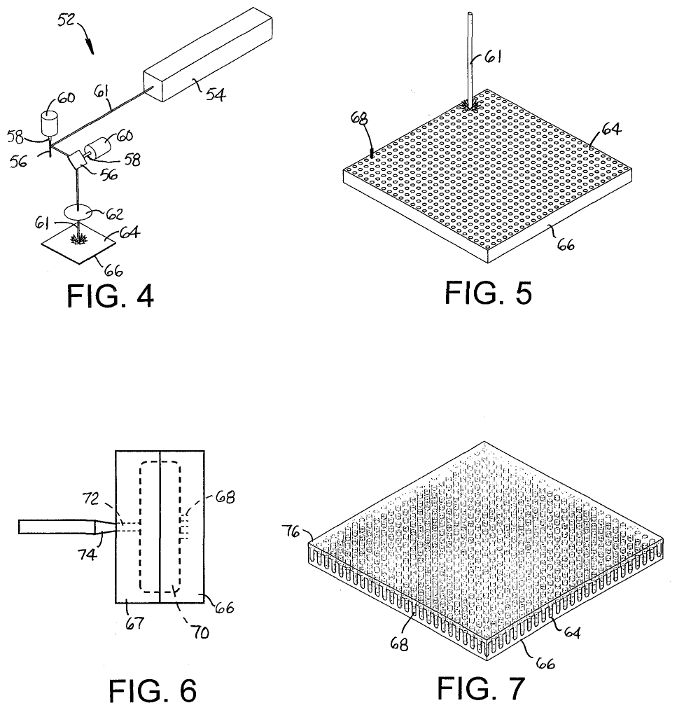

One method of forming the micropillars is shown in FIGS. 4-7. A laser-engraving system 52 that includes a laser source 54 and a pair of mirrors 56 rotatable on orthogonally disposed shafts 58 driven by motors 60 directs a laser beam 61 through a lens 62 onto an inner face 64 of a mold half 66. The motors 60 direct the beam 61 to engrave a pattern of blind-ended microholes 68 in the face 64 of the mold half 66 as shown in more detail in FIG. 5. One example of such a laser-engraving system is manufactured and sold by Cajo Technologies of Kempele, Finland.

A plastic belt module is formed by injection-molding. The mold half 66 with the microholes 68 is joined by a second mold half 67. The two mold halves 66, 67 are closed to form an internal cavity 70 out of cavity, or recess, in each mold half. The joint internal cavity 70 defines the shape of the belt module to be molded. A molten thermoplastic material, such as polyethylene, polypropylene, acetal, or a composite polymer, is injected into the cavity 70 through a system of runners 72 by a nozzle 74. The molten thermoplastic polymer 76 fills the cavity 70 and its microholes 68 as shown in FIG. 7. Heat and pressure are applied to the closed mold to form the belt module. After the module cures, the two mold halves 66, 67 are separated, and the belt module is released. The thermoplastic polymer in the microholes 68 forms the micropillars 48 (FIG. 2) that produce the textured superhydrophobic region 36. A hydrophobic chemical, such as an alkylsilane, can be liquid- or plasma-deposited on the superhydrophobic region to harden it and protect it from premature wear.

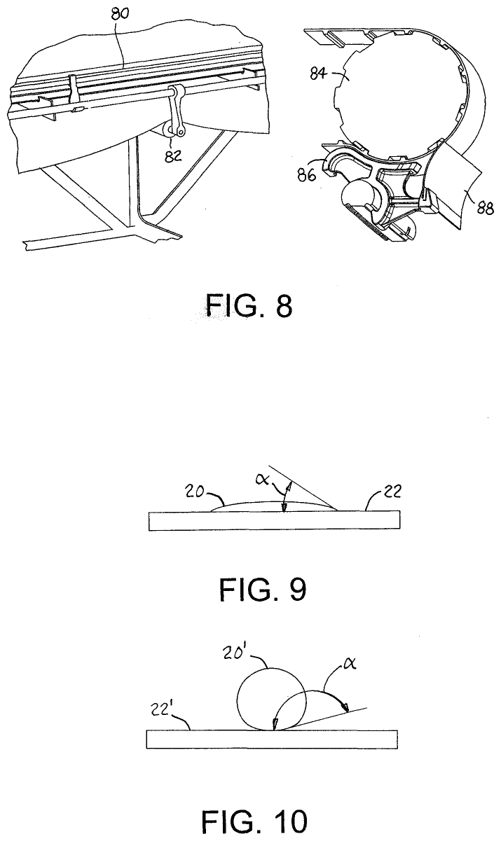

Although the example described the molding of a conveyor belt module, other plastic conveyor belt components can be similarly injection-molded or press-molded with outer-surface superhydrophobic regions. As shown in FIG. 8, other conveyor components that could benefit from water-shedding superhydrophobic surface texturing include side rails 80, return rollers 82 or shoes, sprockets or drum-drive lagging 84, position limiters 86, scrapers 88, and any component that needs cleaning and can be textured with a superhydrophobic region on an outer surface.

Thus, by making conveyor surfaces non-wetting to aqueous solutions, those surfaces remain dry, minimizing contamination from food debris and preventing the growth of bacteria.

What is claimed is:

1. A conveyor component made of plastic and comprising an outer surface having a superhydrophobic region with a superhydrophobic texture.

2. A conveyor component as in claim 1 wherein the superhydrophobic region includes a base and plurality of micropillars extending upward from the base.

3. A conveyor component as in claim 2 wherein the micropillars extend parallel to each other.

4. A conveyor component as in claim 2 wherein the micropillars are arranged in a square- or hexagonal-lattice pattern.

5. A conveyor component as in claim 2 wherein the height of the micropillars is between about 25 μm and about 500 μm.

6. A conveyor component as in claim 2 wherein the diameter of the micropillars is between about 10 μm and about 200 μm.

7. A conveyor component as in claim 2 wherein the distance between adjacent micropillars is between about 10 μm and about 100 μm.

8. A conveyor component as in claim 2 wherein the percentage of the area of the superhydrophobic region on the outer surface occupied by the individual micropillars is between about 20% and about 70%.

9. A conveyor component as in claim 2 wherein the conveyor component is injection molded out of a thermoplastic polymer in a mold having a plurality of blind-ended microholes to form the micropillars.

10. A conveyor component as in claim 9 wherein the microholes are formed in the mold by laser.

11. A conveyor component as in claim 1 comprising a plurality of superhydrophobic regions on the outer surface separated by one or more non-superhydrophobic regions defining one or more channels to drain liquids from the outer surface.

12. A conveyor component as in claim 1 further comprising a hydrophobic chemical deposited on the superhydrophobic region to protect the superhydrophobic texture.

13. A conveyor component as in claim 1 wherein the conveyor component is selected from the group consisting of conveyor belt modules, sprockets, drum-motor laggings, scrapers, return rollers, return shoes, position limiters, and side rails.

14. A conveyor belt made of plastic and comprising an outer surface having a superhydrophobic region with a superhydrophobic texture.

15. A conveyor belt as in claim 14 wherein the superhydrophobic region includes a base and plurality of micropillars extending upward from the base.

16. A conveyor belt as in claim 15 wherein the micropillars are formed in a square- or hexagonal-lattice pattern.

17. A conveyor belt as in claim 15 wherein the percentage of the area of the water-shedding region on the outer surface occupied by the individual micropillars is between about 20% and about 70%.

18. A conveyor belt as in claim 15 wherein the conveyor belt comprises a plurality of conveyor components linked together.

19. A conveyor belt as in claim 14 wherein the superhydrophobic region is formed on a conveying surface on which articles are conveyed.

20. A method for making a conveyor component with a superhydrophobic surface region, the method comprising:
forming a first cavity bounded by an inner face in a first steel mold half;
engraving a pattern of blind-ended microholes in the inner face of the first steel mold half with a laser;
forming a second cavity in a second steel mold half;
closing the mold halves so that the first and second cavities together define the shape of a conveyor component;
injecting a molten thermoplastic polymer into the first and second cavities to fill the cavities and the microholes;
applying heat and pressure to the first and second closed mold halves to form a conveyor component;
opening the first and second mold halves to release the conveyor component from the first and second cavities;
wherein the thermoplastic polymer in the microholes produces micropillars that form a superhydrophobic surface region on the conveyor component.

21. The method of claim 21 further comprising depositing a hydrophobic chemical on the superhydrophobic region of the conveyor component to protect the micropillars.

22. A method for forming microholes in a steel mold comprising:
forming a first cavity in a steel mold bounded by an inner face;
engraving a pattern of blind-ended microholes in the inner face of the steel mold with a laser.

23. The method of claim 23 wherein the pattern of blind-ended microholes is a square- or hexagonal-lattice pattern.
